(19) United States
(12) Patent Application Publication
(10) Pub. No.: US 2014/0061370 A1
(43) Pub. Date: Mar. 6, 2014

(54) Airship and a Method for Controlling the Airship

(71) Applicant: George L. Vojtech, Easton, MD (US)

(72) Inventor: George L. Vojtech, Easton, MD (US)

(21) Appl. No.: 13/393,502

(22) PCT Filed: Feb. 17, 2012
(86) PCT No.: PCT/US12/25680

§ 371 Date: Nov. 6, 2013

Related U.S. Application Data
(60) Provisional application No. 61/444,075, filed on Feb. 17, 2011.

(51) Int. Cl. B64B 1/06

(52) U.S. Cl. CPC B64B 1/06
USPC 244/30

(57) ABSTRACT

According to another aspect of the present invention, an airship includes a plurality of connected segments and a controller that is adapted to dynamically control the movement of each of the plurality of segments relative to one another during flight of the airship.

### CROSS REFERENCE TO RELATED APPLICATIONS

The present applications claims the benefit of provisional U.S. Patent Application No. 61/444,075 filed Feb. 17, 2011, the contents of which are hereby incorporated by reference in their entirety,

### BACKGROUND OF THE INVENTION

1. Field of the Invention

The present invention is directed to an airship and a method for controlling the airship, in particular an airship having a plurality of connected segments wherein the movement of segments relative to one another may be dynamically controlled.

2. Description of the Background of the Invention

A typical airship such as a blimp has a rigid outer envelope filled with a lifting gas such as helium, An airbag or ballonet disposed inside the envelope is used to provide vertical control of the airship and to provide ballast when the airship is aloft, in particular, air is evacuated from the ballonet to outside the airship to cause the airship to ascend and air is pumped into the ballonet to cause the airship to descend. Such an airship may include more than one ballonet to provide ballast and to control the nose-to-tail orientation of the airship.

Because typical airships have rigid outer structures, such airships may not be maneuverable in weather conditions involving high winds and/or turbulent air. Further, high-speed crosswinds may damage the rigid airship. Therefore, such airships are generally operated on calm days or when high-speed winds are not expected.

### SUMMARY OF THE INVENTION

According to one aspect of the present invention, an airship includes head, body, and tail segments and a controller adapted to adjust the attitude of the body segment with respect to one of the head segment and the tail segment.

According to another aspect of the present invention, an airship comprises a plurality of connected segments and a controller adapted to dynamically control the movement of each of the plurality of segments relative to one another during flight of the airship.

According to another aspect of the present invention a method of operating an airship. The airship has a plurality of segments and a coupling between adjacent segments. The method includes the steps of receiving attitude information from each of the plurality of segments and adjusting the pressure inside each segment and the stiffness of the coupling between adjacent segments during flight of the airship in response to the attitude information.

### BRIEF DESCRIPTION OF THE DRAWINGS

FIG. 1 is a side view of an airship;

FIGS. 2A and 2B are additional side views of the airship of FIG. 1;

FIG. 3A is a front view of a segment closer strap of the airship of FIG. 1;

FIG. 3B is a front view of the inside of a segment controller module associated with the segment closer strap of FIG. 3A;

FIG. 4 is a front view of a cross-section of an embodiment of a segment of the airship of FIG. 1;

FIG. 5 is a front view of a cross-section of another embodiment of a segment of the airship of FIG. 1;

FIG, 6 is a block diagram of a control system of the airship of FIG. 1;

FIG. 7 is a side view of a propulsion system of the airship of FIG. 1; and

FIG. 8 is a flowchart of the processing undertaken by an airship controller of FIG, 1.

### DETAILED DESCRIPTION OF THE PREFERRED EMBODIMENTS

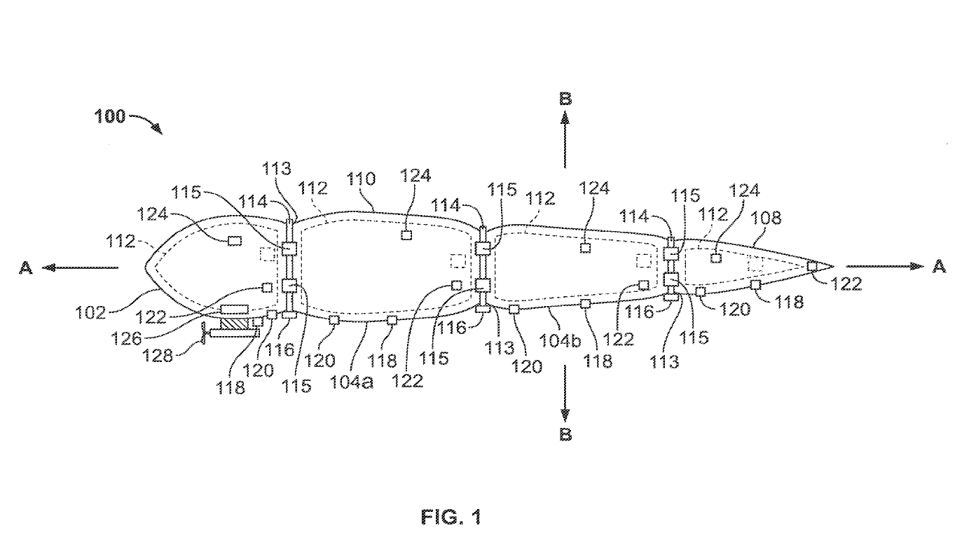

FIG. 1 is a side view of an airship 100 along a longitudinal axis thereof. The airship 100 comprises a head segment 102, two body segments 104a and 104b, and a tail segment 108. It should be apparent that other embodiments of the airship 100 may include more or fewer body segments 104.

The airship 100 includes an outer shell 110 that is a single bag divided into segments, wherein each segment has internal bags 112 described further herein below. At the coupling 113 between each pair of adjacent segments, that is between the segments 102 and 104a, segments 104b and 106, and segments 104b and 108 is a segment closer strap 114 operated by a strap controller module 116 associated therewith. In addition, each segment 102, 104, or 108 includes a sensor module 118, a segment fill fan and valve assembly 120, and a pressure sensor 122 associated with the outer shell 110 surrounding such segment. The sensor module 118 includes multiple instrument sensors including a magnetic compass, an inertial navigation sensor, and/or a three-axis position sensor.

A segment controller 124 is disposed in each segment 102, 104, or 108 that receives measurements from the sensor module 118 and the pressure sensor 122 disposed in such segment, serializes, and transmits such sensor measurements to an airship controller 126. In addition, the segment controller 124 receives from the airship controller 126 signals to adjust the stiffness of the segment 102, 104, or 108 and to increase or decrease the pressure inside the segment 102, 104, or 108. The airship controller 126 also controls a motor driven propulsion module 122 to propel the airship 100.

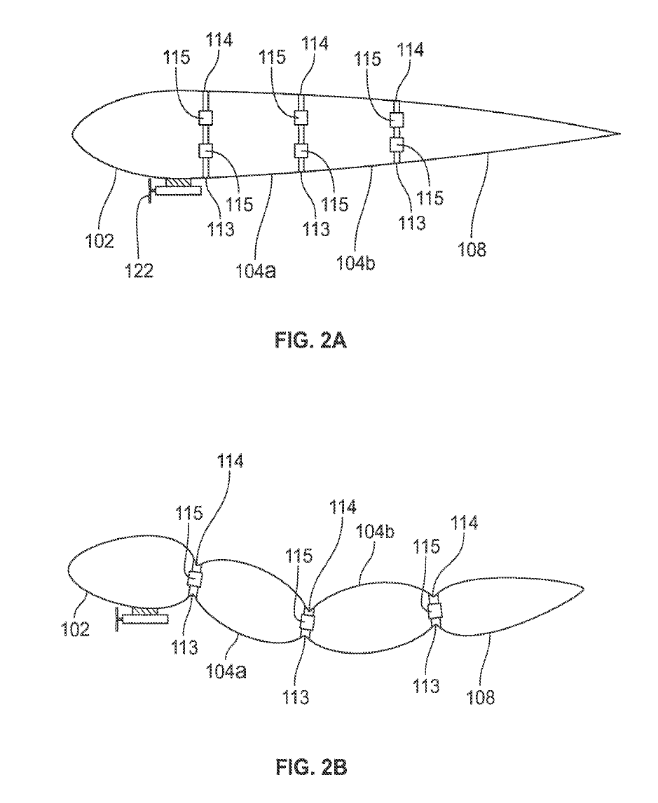

Each segment 102, 104, or 108 of the airship 100 is able to move separately from segments adjacent thereto. The amount of movement is dynamically controlled by independently controlling the pressure inside such segment 102, 104, or 108 and also by adjusting the stiffness of the coupling 113 between adjacent segments. Expanding or constricting the segment closer strap 114 at such coupling 113 increases or reduces the stiffness of such coupling 113. As in the side view shown in FIG. 2A, increasing the pressure inside the segments 102, 104, and 108 and expanding the closer straps 114 between segments 102 and 104a, 104a, and 104b, and 104b and 108 enables the airship to assume a rigid cigar shaped profile that reduces aerodynamic drag. Such a profile and rigid structure may enable the airship 100 to hover over a relatively fixed area or to be propelled forward in low wind conditions.

In one embodiment a plurality of sleeve segments 115 are distributed along the circumference of the outer shell 110 at the coupling 113 between two adjacent segments. In a preferred embodiment such sleeve segments 115 are sewn to the outer shell, The segment closer strap 114 is disposed between such sleeve segments 115 and the outer shell 110. The sleeve segments 115 aid to keep the segment closer strap positioned along the circumference of the outer shell 110. Other ways of securing the segment closer strap 114 to the outer shell 110 will be apparent to those skilled in the art.

Reducing the stiffness of the coupling 113 between adjacent segments by constricting the segment closer strap 114 at such coupling 113 and reducing the internal pressure in such segments allows the portion of the airship 100 that includes such segment to become flexible. FIG. 2B shows a side view of the airship wherein the diameters of the closer straps 114 and the internal pressures of the segments 102, 104, and 108 have been adjusted to allow the airship 100 to become flexible. That is the segments 102, 104, and 108 of the airship 100 are allowed to move with respect with one another. Further, it should be apparent that the diameters of the closer straps 114 between adjacent segments 102 and 104a, 104a and 104b, and 104b and 108 do not have to be identical and therefore stiffness at the couplings 113 between such adjacent segments may vary. In high wind and/or turbulent air environments, such flexibility allows each segment 102, 104, or 108 of the airship 100 to drift into a position that reduces the gradient of the wind with respect to such segment (that is, such segment presents a minimized cross-section to the wind), In this fashion, the airship 100 is able to remain airborne even in high wind and/or turbulent air conditions without being at risk of damage from crosswinds.

The sensor module 118 disposed in each segment 102, 104, or 108 of the airship 100 measures the direction in which such segment is facing and the attitude (e.g., pitch, yaw, and/or roll) of such segment. In addition, the pressure sensor 122 on the portion of the outer shell 110 associated with each segment 102, 104, or 108 measures the internal pressure of such segment. Such pressure measurement provides an indication of the stiffness of the segment 102, 104, or 108 where such measurement was obtained.

Referring once again to FIG. 1, the segment controller 124 disposed on a segment 102, 104, or 108 receives a signal from the airship controller 126 to adjust the pressure inside the outer shell 110 at such segment. In response, the segment controller 124 actuates the segment fill fan and valve assembly 120 to increase or decrease the pressure inside such segment by either drawing air from or exhausting air to, respectively, the atmosphere outside airship 100.

The segment controller 124 disposed on the segment 102, 104, or 108 also receives a signal to adjust the segment closer strap 114 to either increase or decrease the stiffness of the coupling 113 between such segment and another segment adjacent thereto. In response, the segment controller 124 controls the strap controller module 116 to either tighten or loosen such segment closer strap 114.

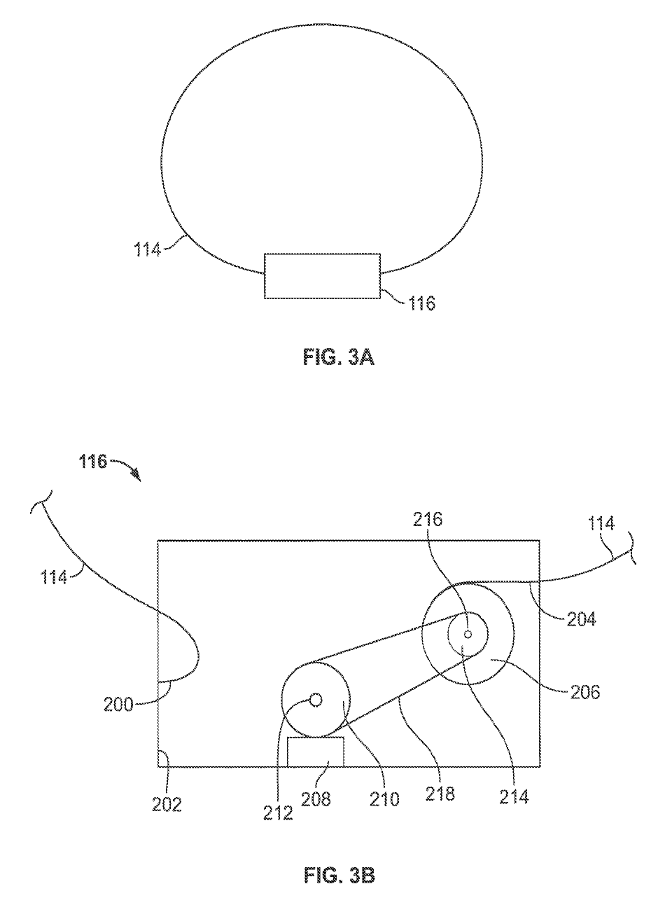

FIG. 3A is a front view of the segment closer strap 114 and the segment controller module 116 associated therewith. FIG. 3B is a front view of the inside of the segment controller module 116. In one embodiment, one end 200 of the segment closer strap 114 is affixed to an inside wall 202 of the segment control module 116. Another end 204 of the segment closer strap 114 is affixed to a strap winder 206. The strap controller module 116 includes a reversible gear motor 208 actuated by the segment controller 116. A first pulley wheel 210 is disposed on a rotatable shaft 212 of the reversible gear motor 208. A second pulley wheel 214 is disposed on a rotatable shaft 216 of the strap winder 206. A belt 218 couples the first pulley wheel 210 with the second pulley wheel 214. When the shaft 212 of the motor 208 rotates, the first pulley wheel 210 also rotates and causes the belt 218 to rotate. Rotation of the belt 218 causes the second pulley wheel 214 to rotate in response and such rotation of the second pulley wheel 214 causes the strap winder 206 to rotate. Rotation of the strap winder 206 in this fashion can release or wind the strap 114 and thereby increase or decrease, respectively, the diameter of the strap at the coupling 113 between two segments.

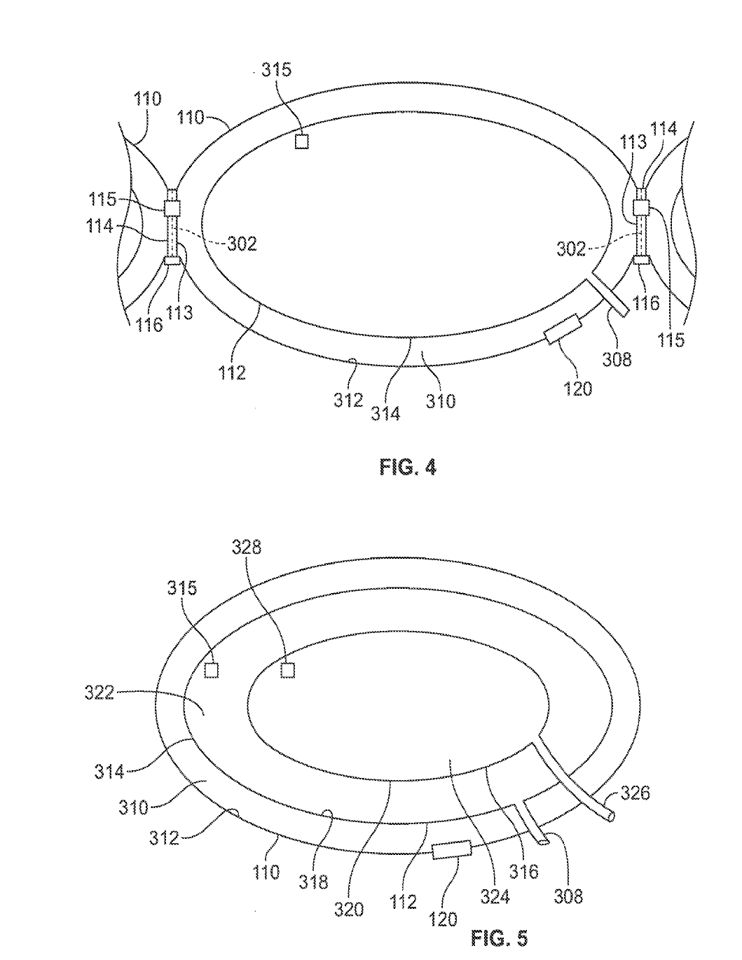

FIG. 4 is a front view of a cross-section of one embodiment of the segment 104 taken along the line A of FIG, 1. It should be apparent that the interiors of the segments 102 and 108 are similar to the interior of the segment 104. The segment closer strap 114 is sewn into the outer shell 110 such that compression or expansion of the segment closer strap 114 causes compression and expansion of the coupling 113 between segments. In some embodiments, a baffle 302 is attached to the outer shell 110 and provides a barrier between segments.

The interior gasbag 112 is filled with a lifting gas through a fill tube 308. Typically, the interior gasbag 112 is filled when the airship 100 is prepared for operation. A pressure sensor 315 disposed on the surface of the gasbag 112 is used to monitor the pressure of the gasbag 112 during filing. In one embodiment, the interior gasbag 112 is filled with enough lifting gas to provide the maximum lift and altitude expect for a flight. In some embodiments, the interior gasbag 112 may be overfilled by a predetermined amount.

As noted above, the fill fan and valve assembly 120 draws air into or evacuates air from the space 310 between the inner wall 312 of the outer shell 110 and the outer wall 314 of the gasbag 112. Such drawing in or evacuation of air allows the control of the buoyancy of the segment 104 to be controlled so that such segment lifts away from or drops toward the ground. The lifting gas in the interior gasbag 112 provides lift by displacing the heavier air in the space 310. Compression of the lifting gas in the interior gasbag 112 increases the density thereof and reduces the amount of lift provided by the lifting gas. The density of the lifting gas in the interior gasbag 112 is controlled by increasing or decreasing the amount of air in the space 310 and thereby compressing or decompressing, respectively, the interior gasbag 112. When the fan and valve assembly 120 is operated to draw air into the space 310, the gasbag 112 is squeezed which effectively increases the pressure in the space 310 and the density of the lifting gas therein. Further, drawing air into the space 310 also increases the rigidity of the portion of the outer shell 110 at the segment 102, 104, or 108 in which such gasbag 112 is disposed. In some embodiments, the desired rigidity of the outer shell 110 and the rigidity of the gasbag 112 are determined prior to flight and altering the rigidity of the outer shell 110 is used to control lift.

In preparation for flight of one embodiment of the airship 100, the interior gasbag 112 is filled with the lifting gas through the fill tube 308 causing the airship 100 to ascend. Air from outside of the airship 100 is drawn through the fan and valve assembly into a space 310 between an inner wall 312 of the outer shell 110 and an outer wall 314 of the gasbag 112. Air is drawn into or removed from the space 310 as necessary until the airship 100 stabilizes at a desired altitude and attitude. During flight, the fan and valve assembly 310 are operated to maintain the airship 100 at a desired altitude and attitude. In this fashion, the space 310 provides ballast to control the altitude and attitude of the airship 100. The amount of air in the space is also controlled to provide rigidity to the portion of the outer shell 110 associated with such segment.

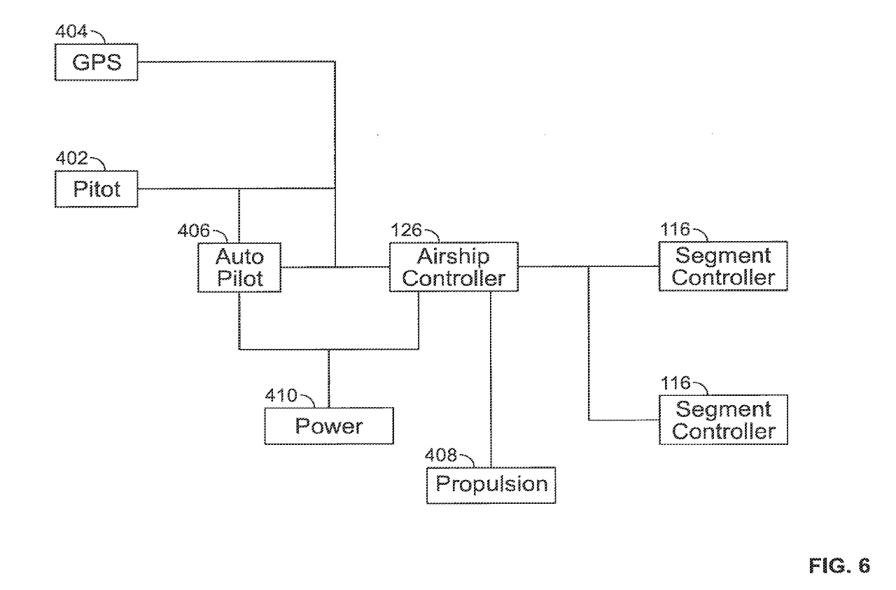

FIG. 5 is a front view of a cross-section of another embodiment of the segment 104 taken along the line B of FIG. 1. In this embodiment, two gasbags 112 and 316 are disposed for each segment 104 inside the outer shell 110 thereof. In particular, the gasbag 316 is disposed inside the gasbag 112. The space 322 between the inner wall 318 of the gasbag 112 and outer wall 320 of the gasbag 316 is filled with air and the interior space 324 of the gasbag 316 is filled with lifting gas. During operation, the fill fan and valve assembly 120 is operated as described above to fill the space 310. The amount of air drawn in or evacuated from space 310 determines the rigidity of the portion of the outer shell associated with the segment 104. A fill tube 308 is provided to fill the space 322 with air and a fill tube 326 is provided to fill the space 324 with a lifting gas. The pressure sensor 315 is used to monitor the filling of the gasbag 112 and a second pressure sensor 328 is used to monitor the filling of the gasbag 316. Drawing air into the space 310 by operating fan and valve assembly 120 also adjusts the pressure on the gasbag 112 and as therefore on the gasbag 316 that contains the lifting gas. In this manner, the altitude of the airship 100 may he controlled during flight as described above.

An embodiment of the airship 100 that comprises a segment shown in FIG. 5, is prepared for flight by the space 324 with the lifting gas through the fill tube 326 causing the airship 100 to rise. As the airship begins to ascend and approach a desired altitude, air from the outside is drawn into the space 322 or released through the fill tube 308 until the airship 100 stabilizes at the desired height. The fill and valve assembly may also be operated as the airship 100 ascends to the desired altitude to draw air into the space 310 to provide additional control.

FIG. 6 is a block diagram of the control system 400 of the airship. The control system comprises the airship controller 126 coupled to a pitot tube 402 and a Global Positioning System (GPS) module 404. As described above, the airship controller 126 is coupled to each segment controller 116 associated with a segment 102, 104, or 108. The segment controller 116 transmits to the airship controller 126 readings from the sensor module 118 and the pressure sensor 122. The airship controller 126 is also coupled to an autopilot unit 406 and a propulsion module 408.

The airship controller 126 monitors the readings from the pitot tube 402 and the GPS 404 module to manage the in-flight vector parameters, air speed, and to control the altitude and attitude of the airship. The airship controller 126 also communicates with the autopilot unit 406 and/or a ground controller in order to keep the airship 126 in a stationary position or to correctly travel to a predetermined location at a predetermined altitude.

The airship controller 126 controls a propulsion module 408 to move the head segment 102 in a particular direction and control the attitude of such segment 102. The airship controller 126 also monitors and adjusts the inflation pressure, the heading, and the attitude of each of the segments 102, 104, and 108 to ensure that the remaining segments 104 and 108 of the airship follow the head segment 102 while minimizing the forces of the wind on the segments of the airship 100. For example, in this manner, the airship controller 126 can guide the airship 100 through areas of heavy wind in a desired direction of travel while minimizing the forces of the wind on the segments of the airship 100. The airship controller 126 controls the pitch of an individual segment 102, 104, or 108 by increasing or decreasing pressure on the gasbag 112 or 320 in such segment to adjust the lift thereof. In addition, the airship controller 126 drives an individual segment 102, 104, or 108 into a preferred orientation by opening or closing the segment closer straps 114 between such segment and segments adjacent thereto.

The control system 400 includes power module 410 to provide electrical power to the components thereof. The power module 410 may be any suitable source of electrical energy including a battery, solar cell, wind generator, or a combination thereof.

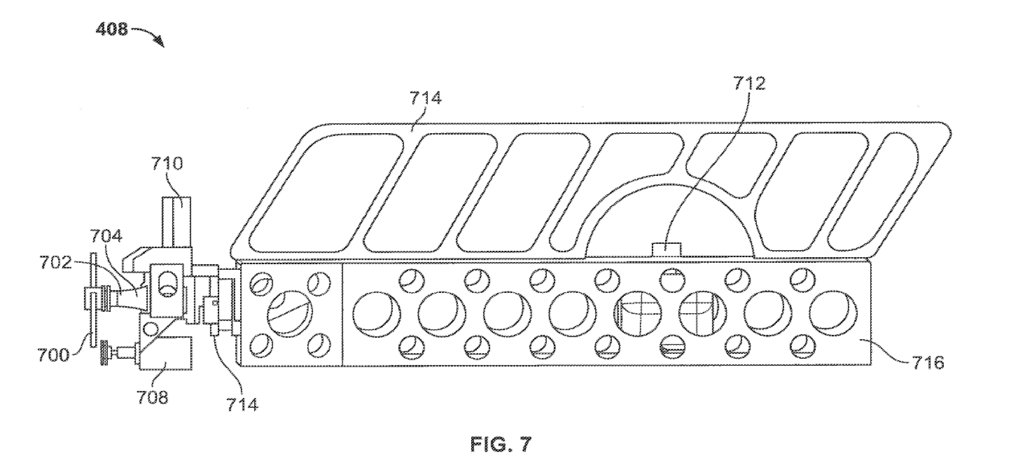

FIG. 7 is a side view of the propulsion module 408 of the airship 100. The propulsion module 408 includes a propeller 700 coupled to a shaft 702 of a motor 704. In one embodiment the propulsion module 408 also includes a starter motor 70$ coupled to the motor 704 that assists in starting the motor 704. In some embodiments the propulsion module 408 includes one or more mufflers 710 to dampen noise generated by the motor 704. The motor 704 is attached to a gimbal 714. The gimbal 714 is coupled to the airship controller 126 so that the airship controller can adjust the pitch and yaw of the motor 704 and thereby control the pitch and yaw of the head segment 102 of the airship 100.

In some embodiments, one or both of the motors 704 and 708 may be powered by combustion of a fuel such as a petroleum fuel. In such embodiments, a fuel tank 712 holds such fuel and is coupled to the motors 704 and/or 708 via fluid lines (not shown). Other types of energy sources known in the art may be used to power the motors 70$ and 708 including solar, wind, a battery or a combination thereof.

The gimbal 714 and the fuel tank 712 are secured to a pod frame 716. A top rail support 714 attaches to the bottom of head segment 102 as shoe in FIG. 1. In one embodiment, reinforcing patches (not shown) are glued and sewn onto the portion of the outer shell 110 associated with the head segment 102. Such reinforcing patches include nylon fabric loops to which the top rail 714 may be secured. The reinforcing patches are aligned in a longitudinal orientation along the centerline of the airship 100. Additional transverse patches (not shown) may also be secured to the portion of the outer shell 110 associated with the head segment 102 to which the top rail support 714 may be secured by, for example, nylon ropes. Securing the top rail support 714 to the reinforcing patches and the transverse patches restricts side-to-side swaying of the pod frame 716.

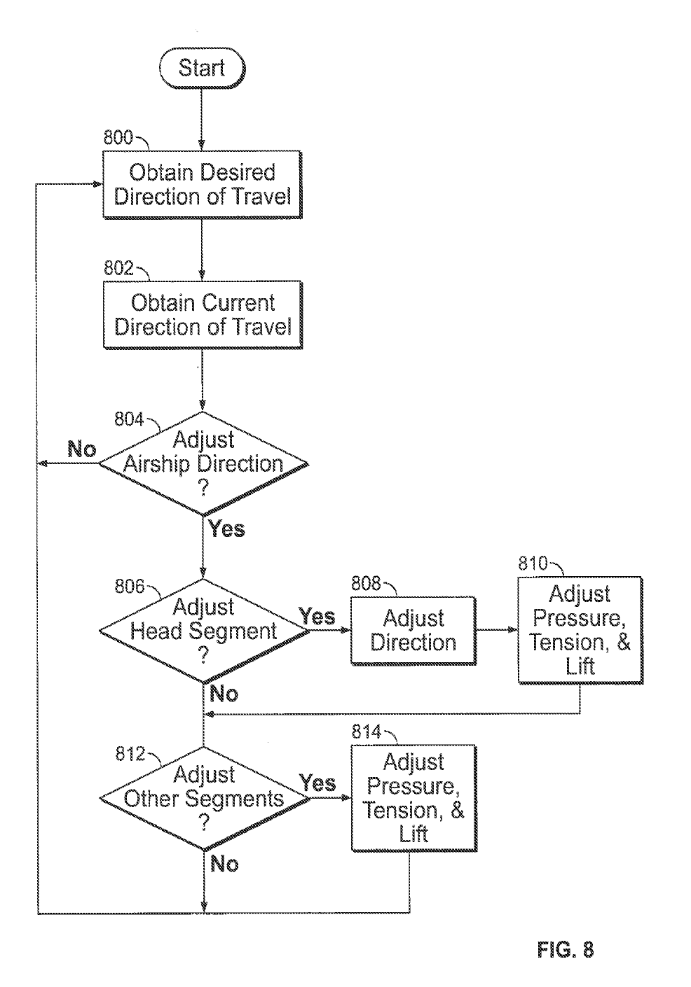

FIG. 8 shows a flowchart of processing undertaken by the airship controller 126 to control the airship. A block 800 obtains the desired direction of travel from the autopilot 406 or from a ground control system (not shown). A block 802 uses information from the pitot tube 402 and the GPS 404 determine the current location, attitude, direction of travel of head segment 102 of airship 100. A block 804 determines if the difference between the current direction of travel and the desired direction of travel warrants adjusting the direction in which the airship 100 is traveling. In some embodiments, the block 804 determines that such an adjustment is warranted if the difference between the desired and actual directions of travel is greater than a predetermined value. In a preferred embodiment, such difference is 15 degrees.

if the block 804 determines that the direction in which the airship 100 is traveling or the attitude of the airship 100 should be modified, a block 806 determines if the attitude and direction of the head segment 102 should be adjusted. Otherwise, processing returns to the block 800.

The block 806 obtains sensor readings from the segment controller 124 associated with head segment 102 and analyzes such reading to determine the attitude and direction of such segment 102. If the block 806 determines that the attitude and/or direction of the head segment 102 do not need to be adjusted, processing proceeds to a block 812. Otherwise, a block 808 adjusts the direction of the head segment 102 by controlling the gimbal 714.

Thereafter, a block 810 directs the segment controller 124 to operate the segment fan and valve assembly 120 to adjust the pressure inside the outer shell 110 of the head segment 102, and/or increase or decrease the pressure on the ballonets to adjust lift. If the orientation of the head segment 102 needs to be adjusted, the airship controller 126 instructs the segment controller 124 to increase or reduce the tension on the segment closer strap 114 between the head segment 102 and the first body segment 104 to drive the head segment 102 into a desired orientation. Thereafter processing proceeds to a block 812.

The block 812 obtains and analyzes the sensor data received from the body segments 104 and the tail segment 108 and determines if the orientation and attitude of such segments needs to be adjusted. If such adjustment is needed, a block 814 directs the segment controller 124 associated with each body segment 104 and the tail segment 108 to control the pressure inside such segment and to adjust the segment closer straps 114 between such segments as described above. After the block 814 processing proceeds to the block 800. In addition, if the block 812 determines that no adjustments are necessary to the body and tail segments 104 and 108, respectively, processing returns to the block 800.

The blocks of the flowchart shown in FIG. 8 may be implemented by programming and/or by hardware and/or firmware as desired. Further, the airship controller may comprise computer executable code stored in a memory associated with the airship controller 126 that undertakes some or all of the blocks shown in the flowchart of FIG. 8.

In a preferred embodiment, the outer shell 102 of the airship 100 is made of a ripstop nylon material. The gasbags 112 inside each segment 102, 104, or 108 are made of Mylar® and helium is used as the lifting gas. In one embodiment the motor 704 in the propulsion system 408 is a Desert Aircraft DA-170 2 stroke mother that generates 17 horsepower and turns the propeller 700 that has two 36-inch blades. In another embodiment, the motor 704 is a Bailey Aviation 4V-200 4-stroke engine that produces 22 horsepower and the propeller 700 that has two or three 39-inch blades.

### INDUSTRIAL APPLICABILITY

Numerous modifications to the airship and method of controlling the same will be apparent to those skilled in the art in view of the foregoing description. Accordingly, this description is to be construed as illustrative only and is presented for the purpose of enabling those skilled in the art to make and use an airship have individually controllable segments. The exclusive rights to all modifications which come within the scope of the appended claims are reserved.

We claim:

1. An airship, comprising:
a head segment;
a body segment;
a tail segment; and
a controller adapted to adjust the attitude of the body segment with respect to one of the head segment and the tail segment.

2. The airship of claim 1, wherein the airship comprises an additional body segment and the controller is adapted to adjust attitude of the body segment with respect to the additional body segment.

3. The airship of claim 2, wherein the body segment and the additional body segment are adjacent segments and move independently from each another.

4. The airship of claim 2, wherein the internal pressure of the body segment and the additional body segment are different.

5. The airship of claim 2, wherein the controller receives measurements of the attitudes of the body segment and the additional body segment from a first and a second sensor, respectively, and such measurements are substantially different.

6. The airship of claim 2, wherein the airship includes a strap between the body segment and the additional body segment.

7. The airship of claim 6, wherein the controller is adapted to adjust a diameter of the segment closer strap.

6. The airship of claim 1, wherein the airship has an outer shell.

7. The airship of claim 6, wherein the outer shell is substantially rigid along the length of the airship when the airship is aloft.

8. The airship of claim 6, wherein when the airship is aloft a first portion of the outer shell of the airship is substantially rigid and a second portion of the outer shell of the airship is substantially flaccid

9. The airship of claim 1, wherein the shape of the airship is changed in response to changes in weather conditions when the airship is aloft.

10. An airship, comprising:
a plurality of connected segments; and
a controller adapted to dynamically control the movement of each of the plurality of segments relative to one another during flight of the airship.

11. The airship of claim 10, wherein the airship comprises an outer shell and the rigidity of the outer shell varies along the length of the airship.

12. The airship of claim 11, wherein the outer shell comprises a first and a second portion associated with a first and a second segment of the plurality of segments, respectively, wherein the first and the second segments are adjacent and the rigidity of the first and second portions is substantially different.

13. The airship of claim 12, wherein the first and the second segments have a coupling therebetween that has a degree of stiffness associated therewith and controller is adapted to adjust the stiffness of the coupling between the first and second segments.

14. The airship of claim 13, wherein a strap circumscribes the airship at the coupling and the controller adjusts a diameter of a strap to adjust the stiffness of the coupling.

15. A method of operating an airship, wherein the airship comprises a plurality of segments and a coupling between adjacent segments, the method comprises the steps of:
receiving attitude information from each of the plurality of segments;
adjusting the pressure inside each segment and the stiffness of the coupling between adjacent segments during flight of the airship in response to the attitude information.

16. The method of claim 15, wherein the adjusting step comprises the step of adjusting the orientation a first segment of the plurality of segments to be substantially different than orientation of a second segment of the plurality of segments.

17. The method of claim 16, wherein the step of adjusting the pressure comprises the step of adjusting the lift of the first segment to be substantially different than the lift of the second segment.

18. The method of claim 16, wherein the airship comprise an outer shell and the rigidity of a portion of the outer shell associated with the first segment is substantially different than the rigidity of a portion of the outer shell associated with the second segment.

19. The method of claim 15, wherein the step of adjusting comprises the step of substantially changing the shape of the airship.

20. The method of claim 15, wherein the steps of receiving and adjusting are undertaken by an airship controller.
